(19) United States
(12) Patent Application Publication
(10) Pub. No.: US 2020/0107535 A1
(43) Pub. Date: Apr. 9, 2020

(54) BED BUG DETECTION AND CAPTURE DEVICE

(71) Applicant: Bed Bugs Inc., Kennesaw, GA (US)

(72) Inventors: Anne M. Hutter, Kennesaw, GA (US); Dennis P. O'Rourke, Kennesaw, GA (US)

(21) Appl. No.: 16/582,623

(22) Filed: Sep. 25, 2019

Related U.S. Application Data
(60) Provisional application No. 62/740,846, filed on Oct. 3, 2018.

(51) Int. Cl. A01M 1/14; A01M 29/34

(52) U.S. Cl. CPC A01M 1/14; B32B 2405/00; A01M 29/34

(57) ABSTRACT

The present invention generally relates to an apparatus and method for detecting and capturing bed bugs. Specifically, the invention relates to a bed bug detection and capture device comprised of a continuous band of double-sided tape with a differential adhesive on its interior and exterior portions.

### FIELD OF THE INVENTION

The present invention generally relates to an apparatus and method for detecting and capturing bed bugs. Specifically, the invention relates to a bed bug detection and capture device comprised of a selectively continuous band of double-sided tape with a differential adhesive on its interior and exterior portions.

### BACKGROUND

Bed bugs are parasitic insects that are commonly found in residential and commercial settings, feeding exclusively on blood, with the Cimex leciularius strain of bed bugs feeding exclusively on human blood. These insects multiply at a rapid rate and it is important to be vigilant in detecting their presence and to take immediate steps to eliminate them before they have had a chance to breed.

Typically, bed bugs hide near or around their food source and feed when their food source is asleep or at rest. As a result, bed bugs are generally found on or near fixtures such as mattresses, box springs, headboards, and couch cushions, making it particularly important to rid areas such as bed- and living-rooms from the presence of bed bugs. Therefore, there is a need in the art for a device for detecting and capturing bed bugs. Embodiments of the present invention are configured to solve this need by providing an adhesive band for placement along the perimeter of mattresses, box springs, and the like to monitor and capture bed bugs residing on or near the mattress or box spring.

### SUMMARY OF THE INVENTION

The present invention is a bed bug control device for monitoring and capturing bed bugs and a method of manufacture and use thereof. In some embodiments, the bed bug control device comprises a plurality of adhesive strips. In any embodiment, the invention provides an easy and practical device designed to detect and capture bed bugs.

### BRIEF DESCRIPTION OF THE DRAWINGS

Accompanying this written specification is a collection of drawings of exemplary embodiments of the present invention. One of ordinary skill in the art would appreciate that these are merely exemplary embodiments, and additional and alternative embodiments may exist and still be within the spirit of the invention as described herein.

FIG. 1 shows a perspective view of a bed bug detection and capture device with one row of adhesive strips in accordance with an embodiment of the present invention.

FIG. 2 shows a cross sectional view of a bed bug detection and capture device having one row of strips with a non-adhesive cover in accordance with an embodiment of the present invention.

FIG. 3 shows a cross sectional view of a bed bug detection and capture device having one row of strips with the non-adhesive cover removed in accordance with an embodiment of the present invention.

FIG. 4 shows a perspective view of a bed bug detection and capture device with two rows of adhesive strips in accordance with an embodiment of the present invention.

FIG. 5 shows a cross sectional view of a bed bug detection and capture device having two rows of adhesive strips with the non-adhesive cover removed in accordance with an embodiment of the present invention.

FIG. 6 shows a cross sectional view of a bed bug detection and capture device having two rows of adhesive strips with the non-adhesive cover removed in accordance with an embodiment of the present invention.

### DETAILED SPECIFICATION

The present invention generally relates to a bed bug monitoring device for detecting and capturing bed bugs.

Embodiments of the present invention are generally directed to an adhesive tape or band configured to be selectively fixed along the perimeter of a bed, box spring, cushion or similar piece of furniture, comprising an adhesive substance disposed along the band and having the ability to capture insects, and in particular, bed bugs.

The bed bug monitoring and capturing device of the present invention may be designed in the form of a band or roll of tape having a plurality of adhesive strips and configured to wrap around the and surround the location desired to be controlled or protected from bed bugs. The device is configured to prevent non-flying insects, particularly bed bugs, from reaching the outer-most top surface of a mattress, or any similar fixture atop which people sit or lay, by blocking the insects' ability to move upwards from inside or below such fixture. In some embodiments, the device is a selectively continuous band configured to surround the perimeter of a fixture.

The bed bug control device could be used in residential settings, upon a user's personal bed, mattress, or similar piece of furniture near which people sleep. The band device may also be used in commercial settings, for example, to protect furniture, box springs and mattresses in hotels and similar public settings wherein multiple users make use of the same mattress or pieces of furniture. One of ordinary skill in the art would appreciate that the bed bug control device could be designed in any number of configurations, sizes and shapes to accommodate mattresses and similar items of varying sizes and configurations and embodiments of the present invention are contemplated for use with any such configuration.

According to embodiments of the present invention, the band is to be placed along the perimeter of a mattress, box spring, or similar item of furniture desired to be protected. In some embodiments, the band is configured to reversibly attach to the outer-most layer of a mattress. In some examples, the band is configured to be selectively disposed atop a fitted sheet.

According to embodiments of the present invention, the device may be used to monitor whether bed bugs are present in the residential or commercial space. In some embodiments, the device may be used to capture live bed bugs and prevent said bed bugs from harming the occupants of the mattress. In some embodiments, the device is configured to be compact and portable, providing a convenient means to carry the device while traveling. In some embodiments, the device is configured as a roll of tape. In some scenarios, a user may apply a first end of the tape to a midsection of the perimeter of a mattress. The user may unwind and apply the tape to the perimeter of the mattress. The tape may then be cut at a second end and applied adjacent to or atop the first end to form a substantially continuous band around the perimeter of the mattress. Once the band is applied to the perimeter of the mattress, the non-adhesive backing may be removed to expose an underlying adhesive material.

According to embodiments of the present invention, the bed bug control device may comprise an internal surface and an external surface, each containing a differential adhesive on their surface. In some embodiments, the interior surface comprises a releasable adhesive configured to adhere the band to the mattress while the band is in use. In some embodiments, the releasable adhesive is a full release adhesive material that is continuous along the interior surface of the band. In some embodiments, the full release adhesive material is configured to be removed from the mattress without leaving any residue or otherwise sullying the mattress when the band or a portion thereof is removed from the mattress.

In some embodiments, the exterior surface is configured with a bed bug capturing material to prevent bed bugs from bypassing the band and gaining access to the top of the mattress, where their potential for harm is the greatest. In some embodiments, the bed bug capturing material is an adhesive element. In some embodiments, the adhesive element may be selected from a range of adhesives available on the market, and may also include attractants such as insect pheromones, flavors and food components to target a specific species. In some embodiments, the adhesive element comprises a non-drying and non-toxic adhesive. In any embodiment, the exteriorly disposed adhesive element is configured to prevent the progression of the bed bugs from within, below, or around the mattress onto the top surface of the mattress. In some embodiments, the adhesive element is initially covered by a non-adhesive backing or cover prior to use of the band. In some examples, the non-adhesive backing may be removed to expose the adhesive element when the band is in use.

According to embodiments of the present invention, the device may comprise a carrier band which is divisible into plurality of strips configured with an adhesive element to capture bed bugs and control their movement. In some embodiments, the band includes one or more separation components configured to enable the separation of one or more selected strips from the band. In some embodiments, the separation components are perforations disposed in a predetermined position. In some embodiments, the band is configured with either or both horizontal and/or vertical perforations and the horizontal perforations are configured to divide the width of the tape or band. In some embodiments, the vertical perforations are configured to divide the length of the tape or band. In some embodiments, the vertically and horizontally disposed perforations are configured such that, before or after application of the band, an individual strip or section of the band may be removed without removing any other strip or section of the band.

According to an exemplary embodiment of the present invention, the width of the tape or band may be approximately three inches. In some embodiments, a horizontal perforation line may be disposed at a mid-point, or approximately one and a half inches from both edges of the tape or band.

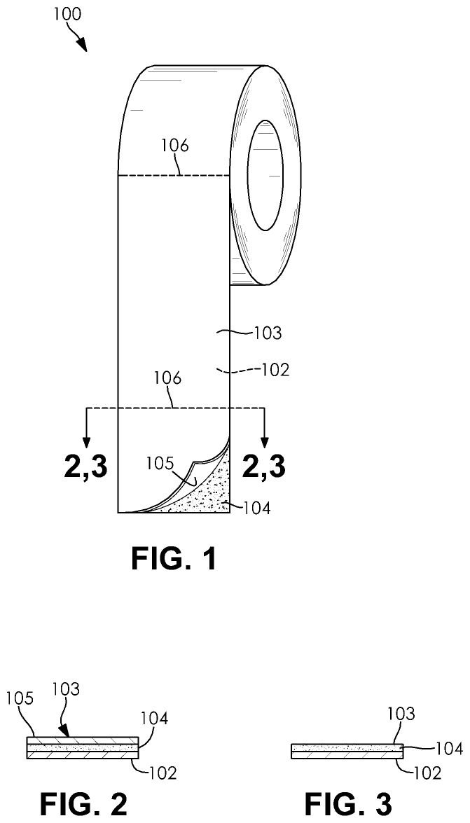

Turning now to the figures, a bed bug control band in accordance with an embodiment of the present invention is shown. Referring to FIGS. 1-3, the bed bug control device 100 includes bed bug capture tape comprising a carrier band 101 having an interior surface 102 and an exterior surface 103. In the illustrated example, the exterior surface 103 includes an adhesive element 104 and is covered by a removable non-adhesive backing 105.

In some embodiments, at least a portion of the carrier band 101 is coated with full release adhesive material. In some embodiments, either or both the exterior surface 103 and the interior surface 102 are coated in a full release adhesive material. In some embodiments, the full release adhesive material is continuous along the interior surface of the band. In some embodiments, the full release adhesive material is configured to be removed from the mattress without leaving any residue or otherwise sullying the mattress when the band 101 or a portion thereof is removed from the mattress.

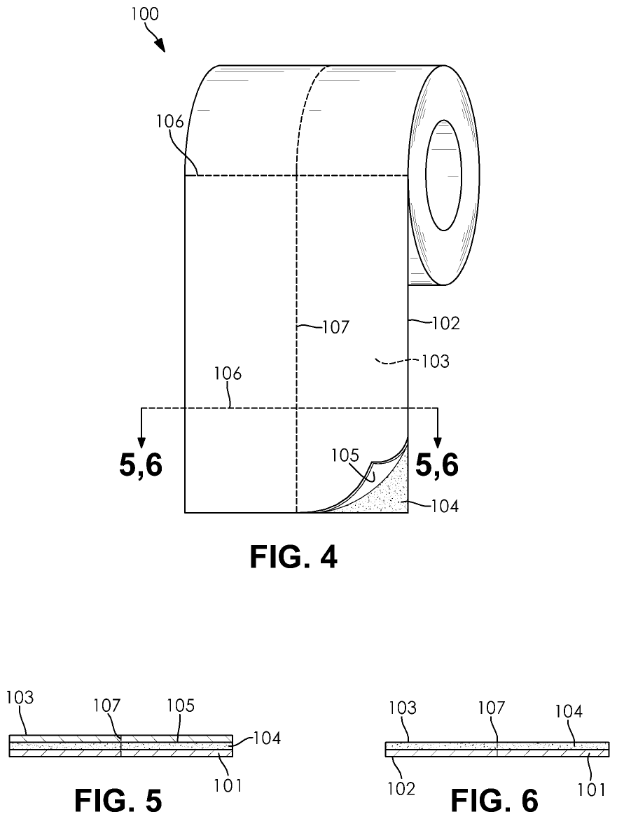

As shown in FIGS. 4-6, in some embodiments, the adhesive element 104 comprises one or more adhesive strips configured to capture bed bugs and control their movement. In some embodiments, each individual adhesive strip is separated from any other adhesive strip by at least one perforated boundary. In some embodiments, the adhesive strips are separated by grooves, hollows, notches or any other similar selectively separable members. One of ordinary skill in the art would appreciate that the adhesive strips may be configured with any number of selectively separable members and embodiments of the present invention are contemplated for use with any such configuration. In the depicted example, the band is configured with both horizontal and vertical perforations 106 and 107, respectively. In some embodiments, the horizontal perforations 106 are configured to divide the width of the tape or band and the vertical perforations 107 are configured to divide the length of the tape or band. In some embodiments, the carrier band 101, including the adhesive element 104 and the non-adhesive backing 105, may be perforated along horizontal and/or vertical lines 106 and 107, respectively. In some embodiments, the vertically and horizontally disposed perforations 106 and 107, respectively, are configured such that an individual strip or section of the band may be removed without removing or displacing any other strip or portion of the band.

In accordance with an exemplary usage scenario of the bed bug control band of the present invention, the band device 100 is applied atop a fitted sheet of a mattress such that the carrier band 101 substantially encircles or surrounds the mattress. For example, the carrier band 101 may substantially surround the sides of the mattress. In some embodiments, the carrier band 101 may be elastic. In some examples, one or more adhesive strips may be disposed on an exterior portion of the carrier band 101. In some scenarios, the adhesive strips are configured to capture bed bugs or detect their presence.

In another exemplary usage scenario, the bed bug control device 100 is configured as a roll of bed bug capture tape used to detect, control and capture bed bugs. In accordance with an exemplary embodiment, a user may apply a first end of the tape to the perimeter of a mattress. The user may unwind the roll and apply the full release adhesive material of the interior surface 102 of the tape to the perimeter of the mattress. The tape may then be cut at a second end and applied adjacent to or atop the first end to form a substantially continuous band around the perimeter of the mattress. Once the carrier band 101 is applied to the perimeter of the mattress, the non-adhesive backing 105 may be cut along one or more perforation lines and selectively removed to expose an underlying adhesive element 104. For example, the non-adhesive backing 105 may be selectively removed from a bottommost strip of the carrier band 101 to expose the underlying adhesive element 104 of the bottommost strip. In some examples, once bed bugs are captured on the exposed adhesive element 104 of the bottommost strip, the bottommost strip may be cut along the horizontal and vertical perforations 106 and 107, respectively, to remove the strip and enable a user to dispose of the selected strip without having to remove any other sections or the entirety of the band. Now, a user may remove the non-adhesive backing 105 of the section previously adjacent to the bottommost strip to expose the adhesive element 104 and detect or capture additional bed bugs.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

In the present disclosure, various features may be described as being optional, for example, through the use of the verb “may:”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of embodiments of the invention, even those disclosed solely in combination with other features of embodiments of the invention, may be combined in any configuration excepting those readily apparent to the person skilled in the art as nonsensical. Likewise, use of the singular and plural is solely for the sake of illustration and is not to be interpreted as limiting.

In the present disclosure, all embodiments where “comprising” is used may have as alternatives “consisting essentially of,” or “consisting of.” In the present disclosure, any method or apparatus embodiment may be devoid of one or more process steps or components. In the present disclosure, embodiments employing negative limitations are expressly disclosed and considered a part of this disclosure.

Certain terminology and derivations thereof may be used in the present disclosure for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an embodiment “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)−(a second number),” this means a range whose limit is the second number. For example, 25 to 100 mm means a range whose lower limit is 25 mm and upper limit is 100 mm.

Any element in a claim herein that does not explicitly state “means for” performing a specified function, or “step for” performing a specific function, is not to be interpreted as a “means” or “step” clause as specified in 35 U.S.C. § 112 (f). Specifically, any use of“step of” in the claims herein is not intended to invoke the provisions of 35 U.S.C. § 112 (f).

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A bed bug detection and capture device, comprising:
a carrier band having opposing first and second sides, at least a portion of the first side configured with an adhesive element and at least a portion of the second side including a releasable adhesive; and
a non-adhesive cover removably attached to the band and enclosing the adhesive element on the first side of the band.

2. The bed bug detection and capture device of claim 1, wherein the carrier band is divisible into one or more adhesive strips.

3. The bed bug detection and capture device of claim 2, wherein the band includes one or more separation components configured to selectively separate at least a portion of the band.

4. The bed bug detection and capture device of claim 3, wherein the separable components comprise one or more perforation lines.

5. The bed bug detection and capture device of claim 1, wherein the releasable adhesive is configured to releasably couple the band to a mattress or fitted sheet.

6. The bed bug detection and capture device of claim 5, wherein the releasable adhesive is configured to be removed from the mattress or fitted sheet without leaving residue when the band or a portion thereof is removed.

7. A bed bug detection and capture device, comprising:
a carrier band having opposing first and second sides, at least a portion of the first side configured with an adhesive element and at least a portion of the second side including a releasable adhesive,
a non-adhesive cover having an interior and an exterior side and removably attached to the band, the interior side enclosing the adhesive element on the first side of the band; and
wherein the capture device is formed as a roll with the releasable adhesive of the interior side in contact with the second side of the band.

8. The bed bug detection and capture device of claim 7, wherein the band is divisible into one or more prescribed strips.

9. The bed bug detection and capture device of claim 8, wherein the band is arranged as two rows of strips aligned parallel to one another.

10. The bed bug detection and capture device of claim 9, wherein each row comprises a plurality of strips, each strip having a length of approximately 12 inches and a width of approximately 1.5 inches.

11. A bed bug detection and capture device, comprising:
A roll comprising a carrier band having a first and second side, at least a portion of the first side configured with an adhesive element and at least a portion of the second side including a releasable adhesive, the band configured with one or more perforations adapted to selectively divide the band into one or more prescribed strips; and
a removable non-adhesive cover having an interior and an exterior side, the interior side enclosing the adhesive element and the exterior side in contact with the releasable adhesive, the cover divisible into one or more strip covering segments.

12. The bed bug detection and capture device of claim 11, wherein the band is arranged as two rows of strips aligned parallel to one another.

13. The bed bug detection and capture device of claim 12, wherein each row comprises a plurality of strips, each strip having a length of approximately 12 inches and a width of approximately 1.5 inches.

14. The bed bug detection and capture device of claim 11, wherein the releasable adhesive is configured to releasably couple the band to a mattress or fitted sheet.
